(19) United States
(12) Patent Application Publication
(10) Pub. No.: US 2021/0279693 A1
(43) Pub. Date: Sep. 9, 2021

(54) SERVER, PROGRAM, AND SETTLEMENT TERMINAL MANAGEMENT SYSTEM

(71) Applicant: TOSHIBA TEC KABUSHIKI KAISHA, Tokyo (JP)

(72) Inventor: Atsushi SEKIMOTO, Narashino Chiba (JP)

(73) Assignee: TOSHIBA TEC KABUSHIKI KAISHA, Tokyo (JP)

(21) Appl. No.: 17/144,773

(22) Filed: Jan. 8, 2021

(30) Foreign Application Priority Data
Mar. 9, 2020 (JP) 2020-040280

(51) Int. Cl. G06Q 20/02; G06Q 20/20; G06Q 20/34; G06Q 10/10; G06Q 30/00; G06Q 40/02

(52) U.S. Cl. CPC G06Q 20/02; G06Q 20/202; G06Q 20/204; G06Q 40/025; G06Q 10/10; G06Q 30/018; G06Q 20/34

(57) ABSTRACT

A server includes a receiving unit configured to receive, from a settlement terminal capable of performing settlement processing by a credit card, a terminal ID for specifying the settlement terminal and a determination instruction. In response to the receiving unit receives the determination instruction, a determining unit is configured to determine, referring to a storing unit correlating and storing the terminal ID for specifying the settlement terminal and credit settlement related items, whether the settlement terminal specified by the terminal ID received by the receiving unit is usable for credit settlement. The server further includes a transmitting unit configured to transmit a determination result of the determining unit to the settlement terminal specified by the terminal ID received by the receiving unit.

### CROSS-REFERENCE TO RELATED APPLICATION

This application claims the benefit of and priority to Japanese Patent Application No. 2020-040280, filed on Mar. 9, 2020, the entire contents of which are incorporated herein by reference.

### TECHNICAL FIELD

Embodiments described herein relate generally to a server, a program, and a settlement terminal management system.

### BACKGROUND

Cashless payments have advanced and settlement by credit cards (hereinafter simply referred to as credit settlement) has been increasing. In the credit settlement, card information of a customer is transmitted from a settlement terminal, with which the customer performs settlement processing, to a credit company server, which is managed by a credit company, via a settlement server, which manages a plurality of settlement terminals. Based on a terminal ID received from the settlement terminal, the settlement server checks whether the settlement terminal is registered as a settlement processing target device. The credit company server performs authorization (credit approval) based on the received card information and performs settlement for a card for which the authorization is performed. In the authorization, the credit company server determines whether the credit card is valid and a use limit amount is not exceeded.

If a settlement terminal for performing credit settlement is set in a store anew, a person in charge of setting performs various settings on the settlement terminal and confirmation work for confirming that the settlement terminal can be used for the credit settlement, including confirmation of connection to the credit company. This confirmation work is performed by the person in charge of connecting the settlement terminal to the credit company server via the settlement server using a test card provided from the credit company. If various settings of the settlement terminal, the settlement server, and the credit company server are correctly performed, data transmission and reception is correctly performed between the settlement terminal and the settlement server and between the settlement server and the credit company server.

Incidentally, a large number of settlement terminals are sometimes introduced into a plurality of stores in the same time period, for example, when a new shopping mall is opened. In such a case, it is necessary to connect all the settlement terminals to the credit company server using the test card for testing and perform the confirmation work. Therefore, the confirmation work takes time.

Related art is described in, for example, JP-A-2002-74225.

### DESCRIPTION OF THE DRAWINGS

FIG. 1 is a diagram illustrating a settlement system including a settlement terminal management system according to an example embodiment;

FIG. 2 is a block diagram illustrating a hardware configuration of a settlement server, according to an example embodiment;

FIG. 3 is a diagram illustrating a data configuration of a terminal management table stored in a storing unit of the settlement server, according to an example embodiment;

FIG. 4 is a diagram illustrating a data configuration of a member store management table stored in the storing unit, according to an example embodiment;

FIG. 5 is a block diagram illustrating a functional configuration of the settlement server, according to an example embodiment;

FIG. 6 is a sequence chart illustrating a flow of confirmation work by a test card, according to an example embodiment; and

FIG. 7 is a flowchart illustrating processing of a control unit of the settlement server, according to an example embodiment.

### DETAILED DESCRIPTION

According to an example embodiment, a server, a program, and a settlement terminal management system capable of achieving improvement of efficiency of confirmation work during settlement terminal setting are provided.

According to at least one embodiment, a server includes: a receiving unit (e.g., a receiver) configured to receive a terminal ID for specifying a settlement terminal and a determination instruction from a settlement terminal capable of performing settlement processing by a credit card; a determining unit (e.g., a determination processor) configured to determine whether the settlement terminal specified by the terminal ID received by the receiving unit is usable for credit settlement, if the receiving unit receives the determination instruction, referring to a storing unit (e.g., a memory) correlating and storing the terminal ID for specifying the settlement terminal and credit settlement related items,; and a transmitting unit (e.g., a transmitter) configured to transmit a determination result of the determining unit to the settlement terminal specified by the terminal ID received by the receiving unit.

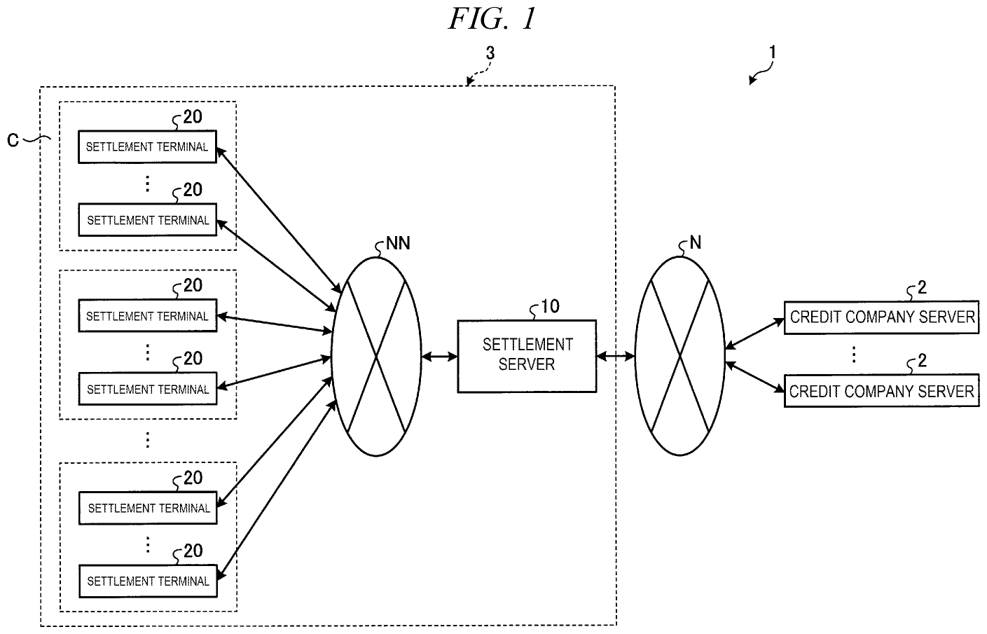

A settlement terminal management system in at least one embodiment is explained below with reference to the drawings. FIG. 1 is a diagram illustrating an overview of a settlement system including the settlement terminal management system. A settlement system 1 includes a plurality of credit company servers 2 and a settlement terminal management system 3. The credit company servers 2 and the settlement terminal management system 3 are connected via a network N. The credit company servers 2 are managed for each of credit companies that issue credit cards. The credit company servers 2 perform authorization and settlement.

The settlement terminal management system 3 includes a settlement server 10, which is a server, and a plurality of settlement terminals 20. The settlement server 10 and the settlement terminals 20 are connected via a network NN. The settlement server 10 is managed by, for example, a company that provides the settlement terminals 20 to a company C (hereinafter referred to as member store C) that operates stores. The member store C sets the settlement terminals 20 respectively in a plurality of stores. The settlement terminals 20 are devices that are connected to POS (Point Of Sales) terminals provided in the stores and are capable of performing settlement processing by credit cards.

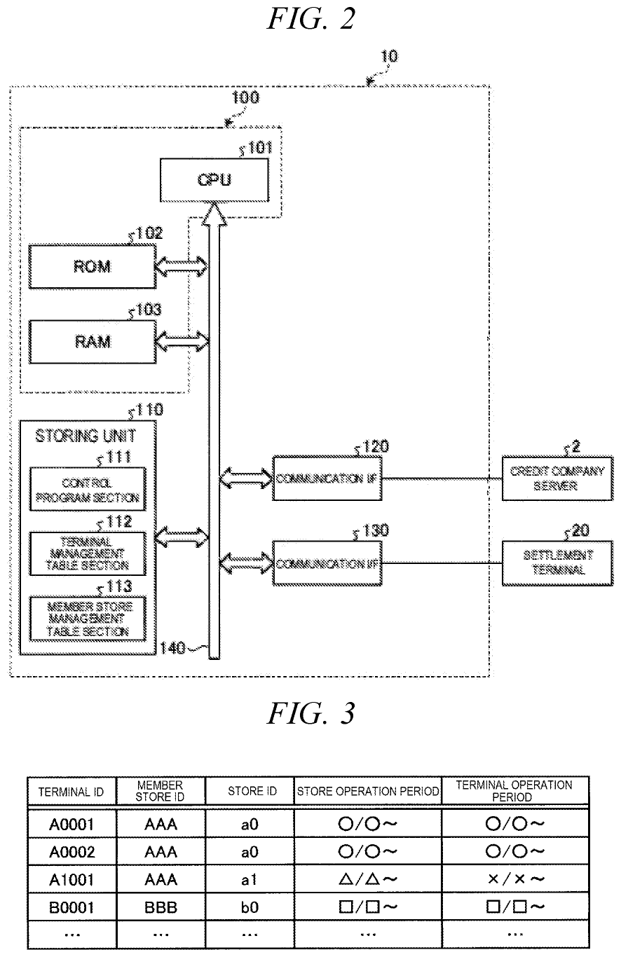

A hardware configuration of the settlement server 10 is explained with reference to FIG. 2. The settlement server 10 includes a control unit 100 (e.g., a controller), a storing unit 110 (e.g., a memory), and communication I/Fs (Interfaces) 120 and 130. The control unit 100, the storing unit 110, and the communication I/Fs (Interfaces) 120 and 130 are connected to one another via a bus 140.

The control unit 100 includes a CPU (Central Processing Unit) 101, a ROM (Read Only Memory) 102, and a RAM (Random Access Memory) 103. The CPU 101, the ROM 102, and the RAM 103 are connected to one another via a bus 140. The CPU 101 controls the entire settlement server 10. The ROM 102 stores various programs such as a program used for driving of the CPU 101 and various data. The RAM 103 is used as a work area of the CPU 101 and loads the various programs and the various data stored in the ROM 102 or the storing unit 110. The CPU 101 operates according to a control program stored in the ROM 102 or the storing unit 110 and loaded in the RAM 103, whereby the control unit 100 executes various kinds of control processing of the settlement server 10.

The storing unit 110 is formed by an HDD (Hard Disk Drive) or the like and includes a control program section 111, a terminal management table section 112, and a member store management table section 113. The control program section 111 is an area for storing various control programs.

The terminal management table section 112 is an area for storing a terminal management table. Content of the terminal management table is registered based on data that, when setting the settlement terminal 20, a member store notifies to a company that manages the settlement server 10. A data configuration of the terminal management table stored in the storing unit 110 of the settlement server 10 is explained with reference to FIG. 3. As illustrated in FIG. 3, the terminal management table correlates and stores a terminal ID, a member store ID, a store ID, a store operation period, and a terminal operation period. The member store ID, the store ID, the store operation period, and the terminal operation period are examples of credit settlement related items used for determining whether the settlement terminal 20 is usable for credit settlement. However, the credit settlement related items are not limited to these items.

The terminal ID is a code that is set in order to specify a settlement terminal set in a store. Similar to the terminal ID, an IP address of the settlement terminal can also be used. The member store ID is a code that is set in order to specify a company that has a member store contract with a credit company. For instance, the member store ID is an identification code for identifying a company that manages a store where the settlement terminal 20 is set. The store ID is a code that is set in order to specify the store where the settlement terminal 20 is set. The store operation period is decided based on the contract between the member store and the credit company, and is a period in which the store can use the credit settlement. The terminal operation period is also decided based on the contract between the member store and the credit company, and is a period in which the settlement terminal 20 set in the store is usable for the credit settlement. For the settlement terminal 20 set when the store opens, the same data as the store operation period is stored in the terminal operation period. In another embodiment, it is assumed that an end of a credit settlement use period is not decided by the contract between the member store and the credit company. Accordingly, only starts of the store operation period and the terminal operation period are specified.

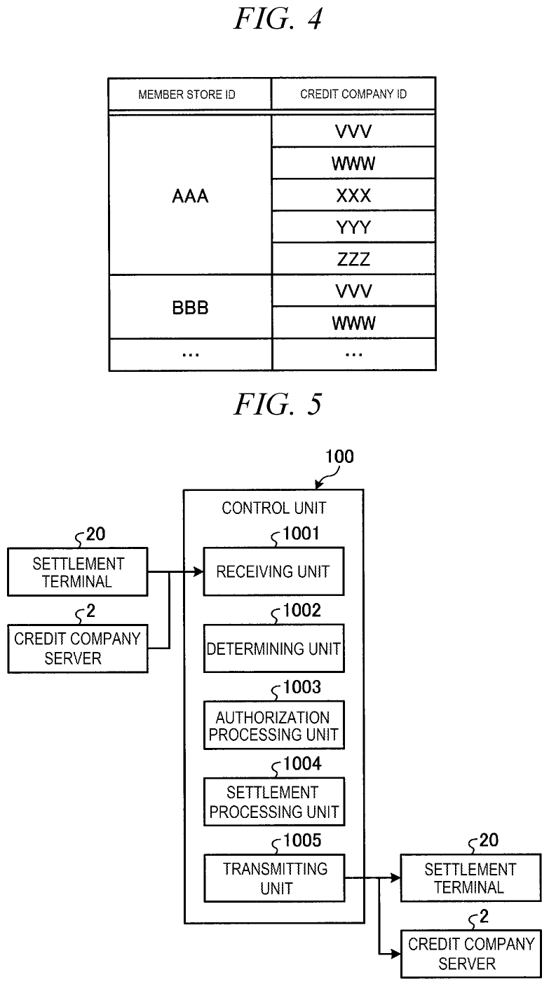

The member store management table section 113 is an area for storing a member store management table. A data configuration of the member store management table stored in the storing unit 110 of the settlement server 10 is explained with reference to FIG. 4. As illustrated in FIG. 4, the member store management table correlates and stores a member store ID and a credit company ID. The member store ID is a code that is set in order to specify a company that has a member store contract with a credit company. The credit company ID is a code that is set in order to specify a credit company that issues credit cards. The credit company performs issuance of credit cards, payment of prices by customers, who purchase commodities, to member stores, invoicing for commodities to the customers, and the like. The credit company is called a credit card company, a card company, and the like as well. In an example illustrated in FIG. 4, in a member store, the member store ID of which is AAA, a credit settlement of a plurality of credit companies (e.g., five credit card companies) is possible. The credit company ID is an example of the credit settlement related items.

Referring back to FIG. 2, the communication I/F 120 is connected to the credit company server 2 via the network N. The communication I/F 130 is connected to the settlement terminals 20 via the network NN. Consequently, the control unit 100 is capable of transmitting and receiving data to and from the credit company server 2 and the settlement terminals 20.

A functional configuration of the control unit 100 of the settlement server 10 is explained with reference to FIG. 5. FIG. 5 is a block diagram illustrating a functional configuration of the settlement server 10. The CPU 101 operates according to the control program stored in the ROM 102 or the storing unit 110, whereby the control unit 100 functions as a receiving unit 1001 (e.g., a receiver), a determining unit 1002 (e.g., a determination processor), an authorization processing unit 1003 (e.g., an authorization processor), a settlement processing unit 1004 (e.g., a settlement processor), and a transmitting unit 1005 (e.g., a transmitter). The functional configurations may be realized by hardware or may be realized by a plurality of computers.

The receiving unit 1001 receives, from the settlement terminal 20, a terminal ID for specifying the settlement terminal 20 and a determination instruction. More specifically, the receiving unit 1001 receives a terminal check telegraphic message (e.g., a terminal check electronic message) from the settlement terminal 20 in confirmation work during setting of the settlement terminal 20. The terminal check telegraphic message includes a determination instruction, a terminal ID of the settlement terminal 20, a store ID of a store where the settlement terminal 20 is set, and a credit company ID of a credit company that issues a credit card usable by the settlement terminal 20. In settlement processing, the receiving unit 1001 receives an authorization request telegraphic message and a settlement request telegraphic message from the settlement terminal 20 (e.g. an authorization request electronic message and a settlement request electronic message). Further, in the settlement processing, the receiving unit 1001 receives an authorization result and settlement information from the credit company server 2.

The determining unit 1002 determines, referring to the storing unit 110 in which the terminal ID and the credit settlement related items are correlated and stored, whether a settlement terminal specified by the terminal ID received by the receiving unit 1001 is usable for the credit settlement. Specifically, the determining unit 1002 determines, referring to the terminal management table stored in the terminal management table section 112, whether a date and time when the terminal ID is received is included in a terminal operation period correlated with the terminal ID and stored. For instance, the determining unit 1002 determines whether the settlement terminal 20 specified by the transmitted terminal ID is a settlement terminal operating in a terminal operation period decided based on the contract between the credit company and the member store and is usable for the credit settlement. Similarly, the determining unit 1002 determines, referring to the terminal management table, whether the store ID received by the receiving unit 1001 coincides with a store ID correlated with the terminal ID, which is received by the receiving unit 1001, and stored. For instance, the determining unit 1002 determines whether the settlement terminal 20 specified by the transmitted terminal ID is set in a store where the settlement terminal 20 should be set and is usable for the credit settlement. Further, the determining unit 1002 determines, referring to the terminal management table and the member store management table stored in the member store management table 113, whether the credit company ID received by the receiving unit 1001 coincides with a credit company ID correlated with the terminal ID, which is received by the receiving unit 1001, and stored. For instance, the determining unit 1002 determines whether a member store that uses the settlement terminal 20 specified by the transmitted terminal ID has a contract with the credit company and the settlement terminal 20 is usable for the credit settlement.

If the receiving unit 1001 receives an authorization request telegraphic message from the settlement terminal 20 during the settlement processing, the authorization processing unit 1003 performs authorization processing. The authorization request telegraphic message includes an authorization request, a terminal ID, card information of a customer, and a card company ID. For example, the authorization processing unit 1003 checks whether the terminal ID received by the receiving unit 1001 is stored in the terminal management table, generates an authorization demand telegraphic message (e.g. an authorization demand electronic message) to the credit company server 2, and selects the credit company server 2 to which the authorization demand telegraphic message is transmitted. The authorization demand telegraphic message includes an authorization demand and the card information of the customer.

If the receiving unit 1001 receives the settlement request telegraphic message from the settlement terminal 20 during the settlement processing, the settlement processing unit 1004 performs the settlement processing. The settlement request telegraphic message includes a settlement request, the terminal ID, the card information of the customer, and settlement target transaction information, and the card company ID. For example, the settlement processing unit 1004 checks whether the terminal ID received by the receiving unit 1001 is stored in the terminal management table, generates a settlement demand telegraphic message to the credit company server 2, and selects the credit company server 2 to which the settlement demand telegraphic message is transmitted. The settlement demand telegraphic message includes a settlement demand, the card information of the customer, and the settlement target transaction information.

The transmitting unit 1005 transmits a determination result of the determining unit 1002 to the settlement terminal 20 specified by the terminal ID received by the receiving unit 1001. Specifically, in the confirmation work during the setting of the settlement terminal 20, the transmitting unit 1005 transmits the determination result determined by the determining unit 1002 to the settlement terminal specified by the terminal ID received by the receiving unit 1001. In the settlement processing, the transmitting unit 1005 transmits the authorization demand telegraphic message and the settlement demand telegraphic message to the credit company server 2. Further, in the settlement processing, the transmitting unit 1005 transmits an authorization result and settlement information to the settlement terminal 20.

The confirmation work performed during the setting of the settlement terminal 20 is explained based on the configuration described above. The confirmation work is work for confirming whether the settlement terminal 20 to be set is usable for the credit settlement. In other words, the confirmation work is work for confirming that various settings in the settlement terminal 20, the settlement server 10, and the credit company server 2 are correctly performed and the credit settlement can be performed by the settlement terminal 20.

Before performing the confirmation work, a member store adopting the settlement terminal 20 performs a contract with a credit company, registration of necessary matters in the settlement server 10, various settings of the settlement terminal 20, and the like. The registration in the settlement server 10 is registration of various kinds of information to be stored in the terminal management table and the member store management table. The setting of the settlement terminal 20 may include setting a terminal ID, a store ID, a member store ID, a credit company ID, and the like besides an IP address, or combinations thereof. First, a person in charge of setting the settlement terminal 20 (hereinafter simply referred to as person in charge) performs a typical connection confirmation using a test card lent from a credit company. The connection confirmation is considered to be a virtual settlement processing. Even if a large number of settlement terminals 20 are set, the connection confirmation is performed on only one settlement terminal (a representative settlement terminal) 20. One representative settlement terminal is set in each store. As an example, one representative settlement terminal is selected out of settlement terminals, the store ID of which is a0 in the terminal management table illustrated in FIG. 3. Subsequently, confirmation work by transmission and reception between the settlement terminal 20 and the settlement server 10, which is a characteristic of at least one embodiment, is performed.

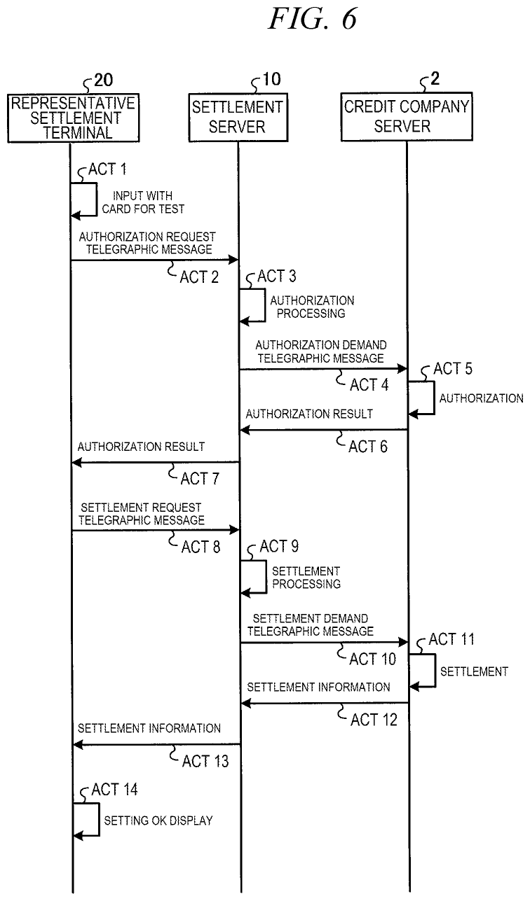

The connection confirmation (e.g., virtual transaction) using the test card is briefly explained with reference to FIG. 6. FIG. 6 illustrates a flow in the case in which the connection confirmation is successfully performed without any error in the connection confirmation using the test card for testing. The person in charge connects the test card to the representative settlement terminal 20 and inputs matters necessary for settlement to the representative settlement terminal 20 or a POS terminal connected to the representative terminal 20 at Act 1. The representative settlement terminal 20 transmits an authorization request telegraphic message to the settlement server 10 based on the input matters at Act 2. The settlement server 10 performs authorization processing at Act 3 and transmits an authorization demand telegraphic message to the credit company server 2 of a credit company that lends the test card at Act 4.

The credit company server 2 performs authorization at Act 5 and transmits an authorization result (e.g., a transaction approval) to the settlement server 10 at Act 6. The settlement server 10 transmits the authorization result received from the credit company server 2 to the representative settlement terminal 20 at Act 7. The representative settlement terminal 20, which receives the authorization result indicating the transaction approval, confirms that the transaction approval is performed and then transmits a settlement request telegraphic message to the settlement server 10 at Act 8. The settlement server 10 performs settlement processing necessary for giving a settlement demand to the credit company server 2 at Act 9 and transmits a settlement demand telegraphic message to the credit company server 2 at Act 10. The credit company server 2 performs settlement at Act 11 and transmits settlement information to the settlement server 10 at Act 12. The settlement server 10 transmits the received settlement information to the representative settlement terminal 20 at Act 13. Upon recognizing that the settlement is completed, the representative settlement terminal 20 performs setting an OK display indicating that various settings of the representative settlement terminal 20 are correctly performed and connection to the credit company server 2 is performed at Act 14.

With the connection confirmation using the test card for testing, it is confirmed that there is no problem in a flow of processing between the representative settlement terminal 20 and the settlement server 10 and there is no problem in a flow of processing between the settlement server 10 and the credit company server 2. Accordingly, in setting the other settlement terminals 20, it only has to be confirmed that there is no problem in the flow of the processing between the settlement terminal 20 and the settlement server 10 because the settlement server 10 and the credit company server 2 are in the same state where the connection confirmation using a test card is performed.

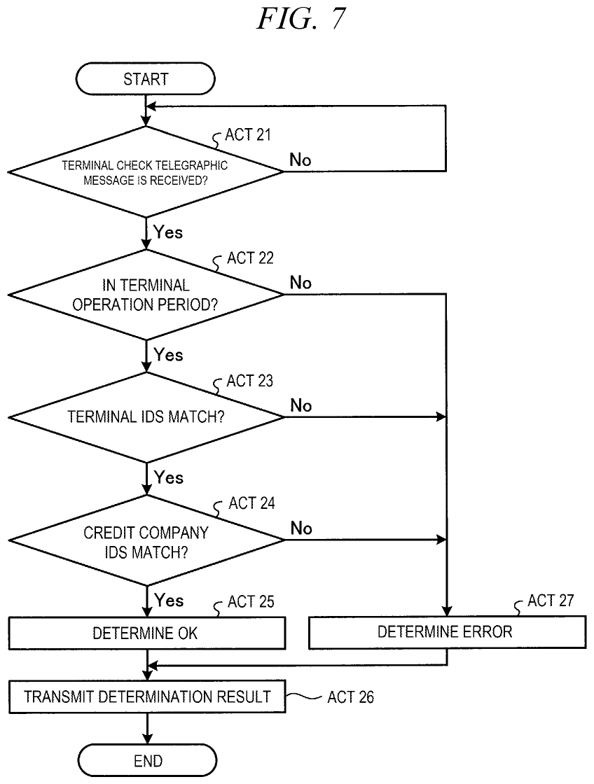

The confirmation work by transmission and reception between the settlement terminal 20 and the settlement server 10, which is a characteristic of at least one embodiment, is explained. On another settlement terminal 20 to be set, the person in charge performs the same setting as the setting for the representative settlement terminal 20 determined as usable for the credit settlement in the connection confirmation using the test card. However, for items set differently for each settlement terminal, for example, an IP address, a terminal ID, and the like, the person in charge performs a unique setting. FIG. 7 is a flowchart illustrating processing of the control unit 100 of the settlement server 10 in the confirmation work.

The control section 100 determines whether the receiving unit 1001 receives a terminal check telegraphic message from the settlement terminal 20 at Act 21. For instance, the control section 100 determines whether an input to the effect that the connection confirmation is performed in the settlement terminal 20 and a terminal check telegraphic message including a transmitted determination instruction is received. If the terminal check telegraphic message is not received (e.g., N at Act 21), the control unit 100 returns to the processing in Act 1. If the terminal check telegraphic message is received (e.g., Y at Act 21), the determining unit 1002 determines whether a date and time of the reception is within a terminal operation period Act 22. Specifically, if the receiving unit 1001 receives the terminal check telegraphic message, the determining unit 1002 refers to the terminal management table section 112. The determining unit 1002 determines whether a received date and time is within a terminal operation period correlated with a terminal ID included in the terminal check telegraphic message and the settlement terminal 20 specified by the terminal ID is usable for the credit settlement.

If the reception date and time of the terminal check telegraphic message is within the terminal operation period (e.g., Y at Act 22), the determining unit 1002 determines whether a received store ID matches with a corresponding store ID stored in the store management table at Act 23. Specifically, the determining unit 1002 compares, referring to the terminal management table section 112, a store ID correlated with the terminal ID included in the terminal check telegraphic message and the store ID included in the terminal check telegraphic message. For instance, the determining unit 1002 determines whether the settlement terminal 20 to be set anew is correctly set in a store where the settlement terminal 20 is scheduled to be set and the settlement terminal 20 is usable for the credit settlement.

Subsequently, if the store IDs match (e.g., Y at Act 23), the determining unit 1002 determines whether the received credit card company ID matches a corresponding credit company ID stored in the member store management table at Act 24). Specifically, the determining unit 1002 compares, referring to the terminal management table section 112 and the member store management table section 113, a credit company ID correlated with the terminal ID included in the terminal check telegraphic message and the credit company ID included in the terminal check telegraphic message. For instance, the determining unit 1002 determines whether the settlement terminal 20 to be set anew is registered based on a member store contract and the settlement terminal 20 is usable for the credit settlement.

If the credit company IDs match (e.g., Y at Act 24), the determining unit 1002 considers that the settlement terminal 20 satisfies predetermined all conditions and determines that the various settings set in the settlement terminal 20 are OK at Act 25. For instance, the determining unit 1002 determines that the settlement terminal 20 specified by the terminal ID received by the receiving unit 1001 is usable for the credit settlement. Subsequently, the transmitting unit 1005 transmits a determination result of the determining unit 1002 to the settlement terminal 20 at Act 26. The control unit 100 ends the processing.

If the reception date and time of the terminal check telegraphic message received by the receiving unit 1001 is not within the terminal operation period in the processing at Act 22 (e.g., N at Act 22), the determining unit 1002 performs an error determination to the effect that the settlement terminal 20 specified by the terminal ID included in the terminal check telegraphic message is not usable for the credit settlement at Act 27. Thereafter, the control unit 100 shifts to the processing at Act 26.

If the store ID received by the receiving unit 1001 does not match the corresponding store ID stored in the store management table in the processing at Act 23 (e.g., N at Act 23), the control unit 100 shifts to the processing at Act 27. For instance, the determining unit 1002 determines that the settlement terminal 20 specified by the terminal ID included in the terminal check telegraphic message is not usable for the credit settlement. Thereafter, the control unit 100 shifts to the processing at Act 26.

If the credit company ID received by the receiving unit 1001 does not match the corresponding credit company ID stored in the member store management table in the processing at Act 24 (e.g., N at Act 24), the control unit 100 shifts to the processing at Act 27. For instance, as in the above explanation, the determining unit 1002 determines that the settlement terminal 20 specified by the terminal ID included in the terminal check telegraphic message is not usable for the credit settlement. Thereafter, the control unit 100 shifts to the processing at Act 26. At Act 26, if the transmitting unit 1005 transmits an error determination result to the settlement terminal 20, the transmitting unit 1005 may transmit erroneous content as well. Consequently, there is an advantage that the person in charge can grasp the erroneous content early. With the processing explained above, it is possible to perform the connection confirmation for the settlement terminal 20 to be set anew other than the representative settlement terminal 20 on which the connection confirmation is successfully performed with the test card.

As explained above, the settlement server 10 in at least one embodiment includes the determining unit 1002 that determines, referring to the storing unit 110 in which the terminal ID and the terminal operation period (e.g., the credit settlement related items) are correlated and stored, whether the settlement terminal 20 specified by the terminal ID received by the receiving unit 1001 is usable for the credit settlement. Accordingly, it is unnecessary to connect all the settlement terminals 20 to be set anew to the credit company server 2 using the test card in order to perform the confirmation work for confirming whether the settlement terminal 20 to be set is usable for the credit settlement. Therefore, it is possible to improve efficiency of the confirmation work during the settlement terminal setting. The settlement server 10 in at least one embodiment is particularly effective if a large number of settlement terminals 20 are set anew.

The settlement server 10 in at least one embodiment uses a terminal operation period as the credit settlement related item for determining whether the settlement terminal 20 is usable for the credit settlement. Accordingly, simply by receiving a terminal ID from the settlement terminal 20, the settlement server 10 can determine that the settlement terminal 20 is a settlement terminal usable based on the contract with the credit company. Therefore, it is possible to easily determine whether the settlement terminal 20 is usable for the credit settlement.

In addition, the settlement server 10 uses the store ID as the credit settlement related item. Accordingly, the settlement server 10 can determine not only whether the settlement terminal 20 is based on the contract with the credit company but also whether the settlement terminal 20 is set in a correct store. Therefore, the person in charge can utilize a store setting situation as a determination standard for determining whether the settlement terminal 20 is usable for the credit settlement.

Moreover, the settlement server 10 in at least one embodiment uses the credit company ID as the credit settlement related item. Accordingly, even if a member store has contracts with a plurality of credit companies and a plurality of kinds of credit cards are used in the settlement terminal 20, the settlement server 10 can determine whether the settlement terminal 20 is usable for each of the credit companies.

In at least one embodiment, although the terminal operation period, the store ID, and the credit company ID are used as the credit settlement related items for determining whether the settlement terminal 20 is usable for the credit settlement, any one may be used. The credit settlement related items are not limited to the above. For example, a member store ID and a store operation time can be used as well.

In at least one embodiment, the control program used in the settlement server 10 may be provided by being recorded in a computer-readable recording medium such as a non-volatile memory (including but not limited to a CD-ROM). The control program executed in the settlement server 10 in at least one embodiment may be provide by being stored on a computer connected to a network such as the Internet and downloaded through the network. Further, the control program may be provided through the network such as the Internet.

At least one embodiment is explained above. However, any such embodiment is presented as an example and is not intended to limit the scope of the invention. Various embodiments can be implemented in other various forms. Various omissions, substitutions, and changes can be made without departing from the spirit of the invention. The at least one embodiment and modifications of the same are included in the scope and the gist of the invention and included in the inventions described in claims and the scope of equivalents of the inventions.

What is claimed is:

1. A server comprising:
a controller configured to
receive, from a settlement terminal configured to perform settlement processing by a credit card, a terminal ID for specifying the settlement terminal and a determination instruction;
in response to receiving the determination instruction, determine, referring to a storage correlating and storing the terminal ID for specifying the settlement terminal and information related to credit settlement, whether the settlement terminal specified by the terminal ID received by the controller is usable for credit settlement; and
transmit a determination result to the settlement terminal specified by the terminal ID received by the controller.

2. The server of claim 1, wherein the information related to credit settlement includes a terminal operation period in which the settlement terminal is capable of performing the settlement processing.

3. The server of claim 2, wherein the terminal operation period is based on a contract between a store and a credit company, and is a period in which the settlement terminal set in the store is usable for the credit settlement.

4. The server of claim 2, wherein the controller is further configured to determine, referring to a terminal management table stored in a terminal management table section, whether a date and time when the terminal ID is received is included in the terminal operation period correlated with the terminal ID and stored.

5. The server of claim 1, wherein the controller is further configured to receive:
a credit company ID for specifying a credit company that issues a credit card usable in the settlement terminal, and
the information related to credit settlement includes the credit company ID.

6. The server of claim 1, wherein the controller is further configured to receive:
a store ID for specifying a store where the settlement terminal is set, wherein
the information related to credit settlement includes the store ID.

7. The server of claim 1, wherein the controller is further configured to receive an authorization request telegraphic message from the settlement terminal during the settlement processing, the includes an authorization request, a terminal ID, card information of a customer, and a card company ID.

8. A method of controlling a server, comprising:
receiving, by a controller, from a settlement terminal capable of performing settlement processing by a credit card, a terminal ID for specifying the settlement terminal and a check instruction;
determining, by the controller, with reference to a storage correlating and storing the terminal ID and information relating to credit settlement, whether the settlement terminal specified by the received terminal ID is usable for credit settlement; and
transmitting a determination result to the settlement terminal specified by the terminal ID received by the controller.

9. The method of claim 8, wherein the information related to credit settlement include a terminal operation period in which the settlement terminal is capable of performing the settlement processing.

10. The method of claim 8, further comprising determining whether the terminal operation period is based on a contract between a store and a credit company, and whether the settlement terminal is set in the correct store.

11. The method of claim 10, further comprising determining, by referring to a terminal management table stored in a terminal management table section, whether a date and time when the terminal ID is received is included in the terminal operation period correlated with the terminal ID and stored.

12. The method of claim 8, further comprising receiving:
a credit company ID for specifying a credit company that issues a credit card usable in the settlement terminal; and
a store ID for specifying a store where the settlement terminal is set,
wherein the information related to credit settlement includes the credit company ID and the store ID.

13. The method of claim 8, further comprising receiving an authorization request telegraphic message from the settlement terminal during the settlement processing, the includes an authorization request, a terminal ID, card information of a customer, and a card company ID.

14. The method of claim 8, further comprising confirming whether the settlement terminal to be set is usable for the credit settlement.

15. A settlement terminal management system comprising:
a plurality of settlement terminals capable of performing settlement processing by a credit card; and
a server configured to manage the plurality of settlement terminals,
the settlement terminal management system being connected to a credit company server that performs settlement based on card information transmitted from the settlement terminal, the server including
a controller configured to
receive, from the settlement terminal, a terminal ID for specifying the settlement terminal and a check instruction;
determine, referring to a storage correlating and storing the terminal ID and information related to credit settlement, whether the settlement terminal specified by the terminal ID received by the receiving unit is usable for credit settlement; and
transmit a determination result to the settlement terminal specified by the terminal ID received by the controller.

16. The settlement terminal management system of claim 15, wherein the information related to credit settlement includes a terminal operation period in which the settlement terminal is capable of performing the settlement processing.

17. The settlement terminal management system of claim 15, wherein the terminal operation period is based on a contract between a store and a credit company, and is a period in which the settlement terminal set in the store is usable for the credit settlement.

18. The settlement terminal management system of claim 15, wherein the controller is further configured to determine, referring to a terminal management table stored in a terminal management table section, whether a date and time when the terminal ID is received is included in the terminal operation period correlated with the terminal ID and stored.

19. The settlement terminal management system of claim 15, wherein the controller is further configured to receive:
a credit company ID for specifying a credit company that issues a credit card usable in the settlement terminal, wherein
the information related to credit settlement includes the credit company ID.

20. The settlement terminal management system of claim 15, wherein the controller is further configured to receive:
a store ID for specifying a store where the settlement terminal is set, wherein
the information related to credit settlement includes the store ID.
